(19) United States
(12) Patent Application Publication
(10) Pub. No.: US 2024/0333039 A1
(43) Pub. Date: Oct. 3, 2024

(54) DYNAMICALLY FORMING A WIRELESS POWER GRID FROM NATURAL RESOURCES

(71) Applicant: International Business Machines Corporation, Armonk, NY (US)

(72) Inventors: Sarbajit K. Rakshit, Kolkata (IN); Jagabondhu Hazra, BANGALORE (IN); Manikandan Padmanaban, BANGALORE (IN)

(21) Appl. No.: 18/191,907

(22) Filed: Mar. 29, 2023

(51) Int. Cl. H02J 50/40; H02J 3/38

(52) U.S. Cl. CPC H02J 50/402; H02J 3/381; H02J 2300/22; H02J 2300/28

(57) ABSTRACT

Computer-implemented methods for forming a wireless power grid in an environment are provided. Aspects include determining an activity to be performed by a set of data collection devices in the environment, obtaining geographic data regarding the environment, and identifying natural power sources in the environment based on the geographic data. Aspects also include deploying power generation devices to the natural power sources in the environment, deploying the set of data collection devices in the environment to perform the activity, and deploying a plurality of wireless power transmission devices to the environment. Aspects further include instructing the power generation devices to collect power from the natural power sources and to wirelessly transmit power to one of the plurality of wireless power transmission devices and instructing the one of the plurality of wireless power transmission devices to wirelessly transmit power to one of the set of data collection devices.

### BACKGROUND

The present disclosure generally relates to power generation and distribution, and more specifically, to dynamically forming a wireless power grid from natural resources to supply power in any activity zone.

It is often desirable to perform surveys or inspections using robotic electronic devices in environments that do not have existing, or functional, power grids. For example, in remote areas that have no power grid or in developed areas that have suffered an outage to the power grid. Since, robotic electronic devices require electricity to operate and often have a limited battery capacity, recharging the robotic electronic devices is required to complete the surveys or inspection.

### SUMMARY

Embodiments of the present disclosure are directed to computer-implemented methods for forming a wireless power grid in an environment. According to an aspect, a computer-implemented method includes determining an activity to be performed by a set of data collection devices in the environment, obtaining geographic data regarding the environment, and identifying natural power sources in the environment based on the geographic data. The computer-implemented method also includes deploying power generation devices to the natural power sources in the environment, deploying the set of data collection devices in the environment to perform the activity, and deploying a plurality of wireless power transmission devices to the environment. The computer-implemented method further includes instructing the power generation devices to collect power from the natural power sources and to wirelessly transmit power to one of the plurality of wireless power transmission devices and instructing the one of the plurality of wireless power transmission devices to wirelessly transmit power to one of the set of data collection devices.

Other embodiments described herein implement features of the above-described method in computer systems and computer program products.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram of an example computer system for use in conjunction with one or more embodiments of the present disclosure;

FIG. 2 depicts a schematic diagram of an environment having a wireless power grid in accordance with one or more embodiments of the present disclosure;

FIG. 3 depicts a block diagram of a system for powering data collection devices by a wireless power grid in accordance with one or more embodiments of the present disclosure;

FIG. 4 is a flowchart of a method for forming a wireless power grid in an environment in accordance with one or more embodiments of the present disclosure;

FIG. 5 depicts a power generation grid for an environment in accordance with one or more embodiments of the present disclosure; and

FIG. 6 depicts an energy loss grid for an environment in accordance with one or more embodiments of the present disclosure.

### DETAILED DESCRIPTION

As discussed above, it is often desirable to perform surveys or inspections using robotic electronic devices in environments that do not have existing, or functional, power grids. However, the robotic electronic devices require electricity to operate and often have a limited battery capacity, recharging the robotic electronic devices is required to complete the surveys or inspection. In exemplary embodiments, methods, systems, and computer program products are provided which dynamically form a wireless power grid from natural resources to supply power to the robotic electronic devices in an activity zone. In exemplary embodiments, the wireless power grid is formed by deploying power generation devices into an environment to collect power from natural power sources in the environment. The wireless power grid also includes wireless power transmission devices that are configured to receive power from the power generation devices and to provide power to data collection devices, i.e., the robotic electronic devices. As a result, the data collection devices are able to operate in the environment for prolonged periods.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as forming a wireless power grid 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

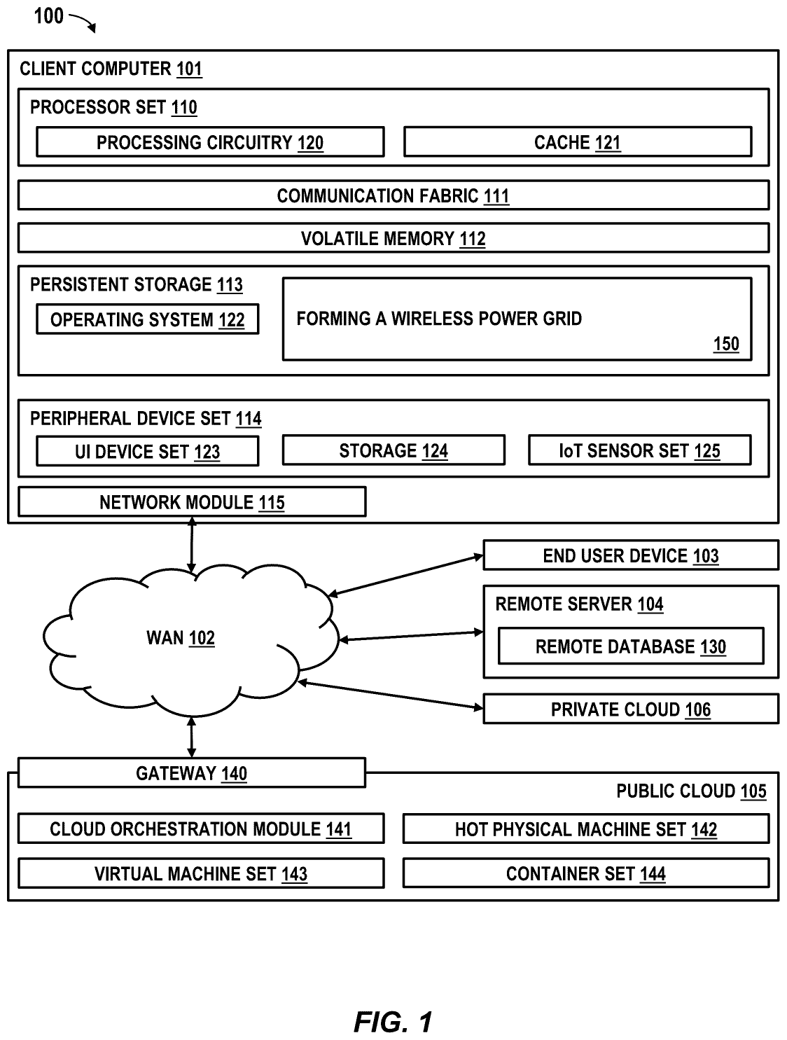

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

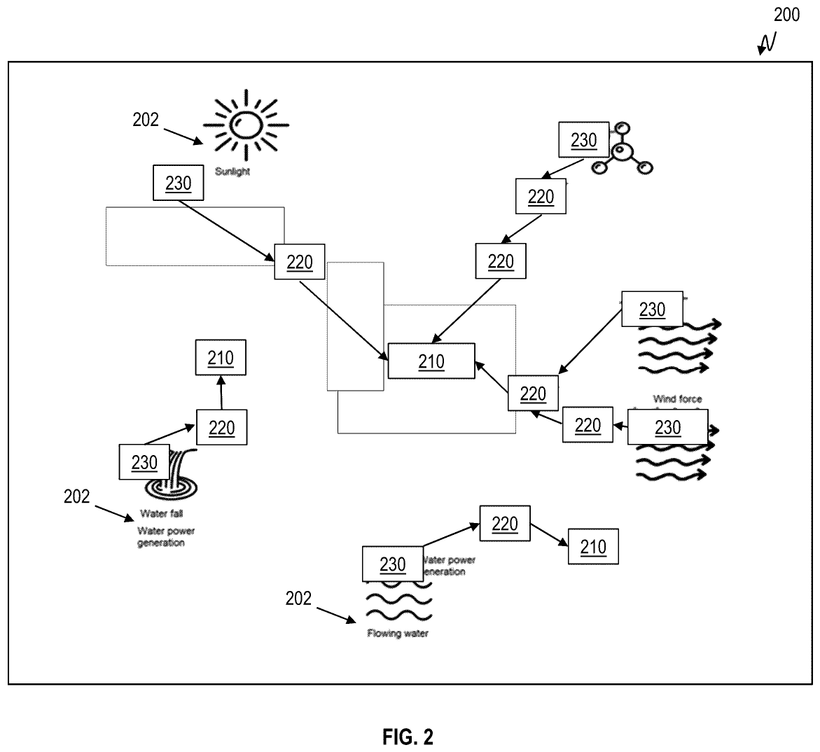

Referring now to FIG. 2 a schematic diagram of an environment 200 having a wireless power grid in accordance with one or more embodiments of the present disclosure is shown. In one embodiment, the environment 200 includes a plurality of data collection devices 210, a plurality of power generation devices 230 and a plurality of wireless power transmission devices 220. As illustrated, each of the plurality of power generation devices 230 are located in the environment 200 such that the power generation devices 230 are able to generate power from a natural power source 202. In exemplary embodiments, the natural power source 202 includes one of solar power, hydro power, wind power, or chemical power. In exemplary embodiments, depending on the location of the power generation devices 230 and the data collection devices 210, one or more wireless power transmission devices 220 are disposed between the power generation devices 230 and the data collection devices 210 to facilitate wireless power transfer from the power generation devices 230 to the data collection devices 210.

In exemplary embodiments, the data collection devices 210 are robotic electronic devices that are configured to survey the environment 200 and/or collect data regarding the environment. In an exemplary embodiment, the data collection devices 210 are configured to survey an environment by traversing the environment to gather information about the terrain, topography, and other features of a particular area. The data collection devices 210 can utilize one or more of a global positioning system (GPS), cameras, LiDAR and ground penetrating radar (GPR) to collect data regarding the environment. In general, GPS is to determine the location of points on land. GPS receivers can determine the latitude, longitude, and elevation of a point on land by receiving signals from GPS satellites. LiDAR uses a laser scanner to measure the distance between the scanner and the ground. The scanner emits laser pulses and measures the time it takes for the pulses to reflect back to the scanner, which can be used to calculate the distance between the scanner and the ground. GPR uses radar waves to penetrate the ground and detect subsurface features, such as buried utilities or geological formations.

In exemplary embodiments, the data collection devices 210 are robotic electronic devices that are configured to collect data regarding the environment. For example, in one embodiment the data collection devices 210 include Geiger counters that are used to measure radiation levels in the environment. In another embodiment, the data collection devices 210 include air quality sensors that are used to measure various pollutants in the air, such as particulate matter, volatile organic compounds (VOCs), carbon monoxide, and nitrogen dioxide. In exemplary embodiments, the data measured by the data collection devices 210 is collected and stored for subsequent analysis.

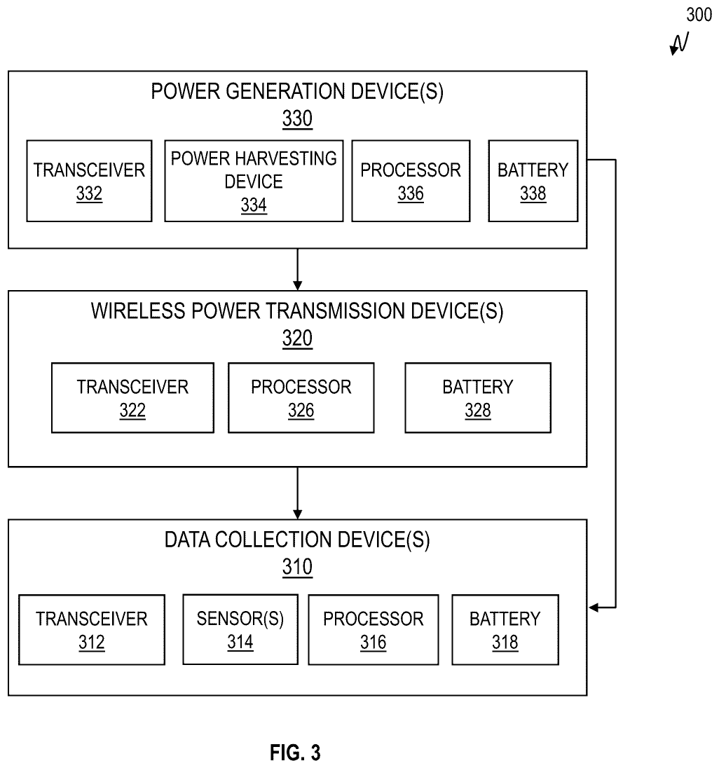

Referring now to FIG. 3, a block diagram of a system 300 for powering data collection devices by a wireless power grid in accordance with one or more embodiments of the present disclosure are shown. As illustrated, the system 300 includes one or more data collection devices 310 that are configured to wirelessly receive power from one or more wireless power transmission devices 320 and/or a power generation device 330. In exemplary embodiments, electromagnetic waves are used to transmit power between the power generation device 330 and one or more wireless power transmission devices 320 and the data collection devices 310 over a distance without the need for physical wires or cables. The use of microwaves to wirelessly transmit power involves converting electrical power into microwaves, which are then transmitted through the air using an antenna. The microwaves are then received by another antenna and converted back into electrical power, which can be used to power electronic devices or charge batteries. In another embodiment, laser-based wireless power transmission that involves using lasers to transfer power over a distance can be used. Laser-based wireless power transmission works by converting electrical power into light, which is then directed through the air using a laser beam. The light is then received by a photovoltaic cell, which converts the light back into electrical power.

In exemplary embodiments, the data collection devices 310 are robotic electronic devices that include a transceiver 312, one or more sensors 314, a processor 316 and a battery 318. In exemplary embodiments, the sensors 314 are configured to collect data regarding the environment that the data collection device 310 is disposed in. Depending on the type of survey being conducted, the sensors 314 may collect air or soil samples, take pictures, perform lidar or radar scans or the like. The samples may be returned to a central location for further analysis or the samples may be disposed of after the data collection device 310 obtains a desired measurement from the samples. The transceiver 312 is configured to wirelessly communicate with other data collection devices 310, one or more wireless power transmission devices 320 and one or more power generation devices 330. In exemplary embodiments, the wireless communication between the devices 310, 320, 330 is used to exchange the operation status, battery level, and location of each of the devices. In addition, the transceiver 312 is configured to receive wireless power transmission from one or more wireless power transmission devices 320 and one or more power generation devices 330. In exemplary embodiments, the data collection device 310 is configured to store power received from the wireless power transmission device 320 in battery 318. The processor 316 is configured to control the operation of the data collection device 310. The processor 316 a central processing unit, an application-specific integrated circuit (ASIC), a digital signal processor, a field-programmable gate array (FPGA), a digital circuit, an analog circuit, and combinations thereof.

In exemplary embodiments, the wireless power transmission devices 320 are robotic electronic devices that include a transceiver 322, a processor 326, and battery 328. The wireless power transmission devices 320 may be embodied in a vehicle such as an aerial vehicle or a terrestrial vehicle, which may be remotely controlled by an operator or be configured to be autonomously operated. The transceiver 322 is configured to wirelessly communicate with other wireless power transmission devices 320, one or more data collection devices 310, and one or more power generation devices 330. In addition, the transceiver 322 is configured to receive wireless power from one or more wireless power transmission devices 320 and one or more power generation devices 330. In exemplary embodiments, electromagnetic waves are used to transmit power between the power generation device 230 and one or more wireless power transmission devices 320 over a distance. The processor 326 is configured to control the operation of the wireless power transmission device 320. The processor 326 includes a central processing unit, an application-specific integrated circuit (ASIC), a digital signal processor, a field-programmable gate array (FPGA), a digital circuit, an analog circuit, and combinations thereof. In exemplary embodiments, the wireless power transmission device 320 is configured to store power received from the power generation device 330 in battery 328.

In exemplary embodiments, the power generation devices 230 are robotic electronic devices that include a transceiver 332, a power harvesting device 334, a processor 336, and battery 338. In exemplary embodiments, the power harvesting device 334 is one of a hydroelectric power generation device, a solar power generation device, and a wind power generation device. The power harvesting device 334 is configured to harvest power from a natural power source and to store the harvested power in battery 338. The processor 336 is configured to control the operation of the wireless power transmission devices 320. The processor 326 includes a central processing unit, an application-specific integrated circuit (ASIC), a digital signal processor, a field-programmable gate array (FPGA), a digital circuit, an analog circuit, and combinations thereof. The transceiver 332 is configured to wirelessly communicate with one or more of the other power generation devices 230, one or more data collection devices 310 and one or more wireless power transmission devices 320. In addition, the transceiver 332 is configured to transmit wireless power to one or more wireless power transmission devices 320 and one or more power generation devices 330.

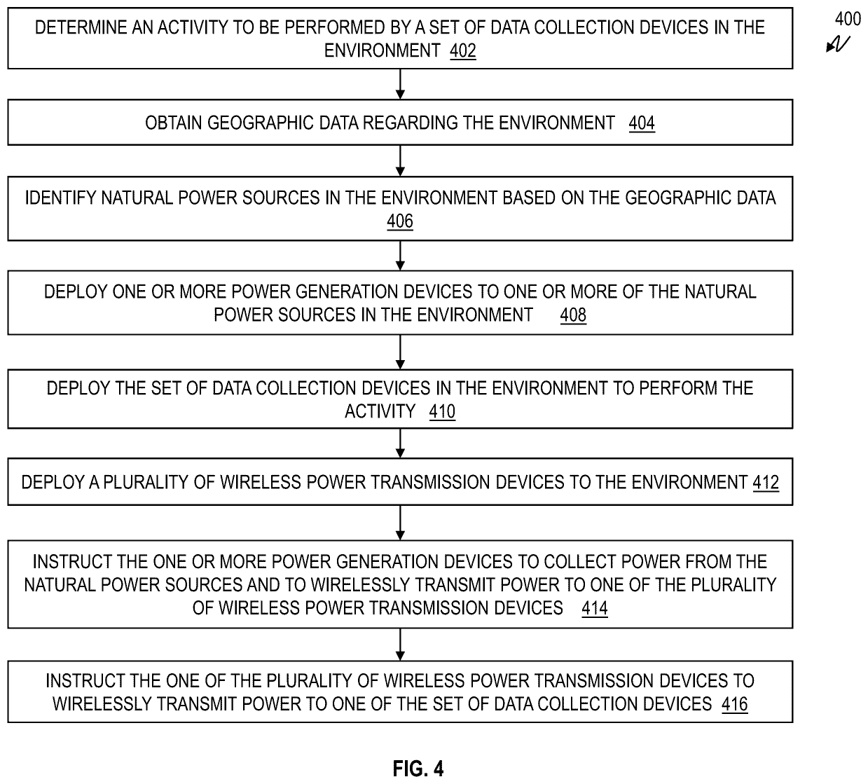

Referring now to FIG. 4, a flowchart of a method 400 for forming a wireless power grid in an environment in accordance with one or more embodiments of the present disclosure is shown. In exemplary embodiments, the method 400 is performed by a computer 101, such as the one shown in FIG. 1, that controls the operation of the data collection devices, the wireless power transmission devices, and the power generation devices. The method 400 includes determining an activity to be performed by a set of data collection devices in the environment. In exemplary embodiments, determining the activity includes calculating the total power required by the set of data collection devices to complete the activity. In one example the total power required is calculated based on the power consumption needs of the data collection devices that will be deployed and based on the size of the environment to be surveyed. For example, the power needed per square mile for the type of survey being conducted can be calculated and the total power can be obtained by multiplying the per square mile power consumption of the data collection devices by the total area of the environment to be surveyed.

Next, as shown at block 404, the method 400 includes obtaining geographic data regarding the environment. In exemplary embodiments, the geographic data regarding the environment include images of the environment, radar images of the environment, a map of the environment, solar, wind and/or wave activity forecasts for the environment, and the like. The geographic data can be obtained via images of the environment captured from one or more of a high-altitude aerial survey, images captured from a satellite, radar maps illustrating wind, solar, cloud conditions for the environment, and combinations thereof. At block 406, the method 400 includes identifying natural power sources in the environment based on the geographic data. In exemplary embodiments, the natural power sources can be identified using a trained machine learning model that analyze the obtained geographic data and to label potential natural power sources. In another embodiment, the natural power sources are identified and labeled by a user that manually reviews the obtained geographic data. In exemplary embodiments, the natural power sources may include one or more of a solar power source, a hydro power source, wind power source, or a chemical power source. In exemplary embodiments, each identified natural power source is labeled with a type of the natural power source, which is used to determine a type of power generation device that is needed to collect power from the natural power source.

The method 400 also includes deploying one or more power generation devices to one or more of the natural power sources in the environment, as shown at block 408. In exemplary embodiments, the number of the one or more power generation devices is determined based at least in part on the total power required. In exemplary embodiments, the deployed power generation devices include multiple different types of power harvesting devices and are deployed to the identified locations of the natural power sources. Next, as shown at block 410, the method 400 includes deploying the set of data collection devices in the environment to perform the activity.

The method 400 further includes deploying a plurality of wireless power transmission devices to the environment, as shown at block 412. In exemplary embodiments, the deployment of the power generation devices, the power transmission devices and the data collection devices is initiated by a user after the number and deployment location for each of the power generation devices, the power transmission devices and the data collection devices has been determined. Next, at block 414, the method 400 includes instructing the one or more power generation devices to collect power from the natural power sources and to wirelessly transmit power to one of the plurality of wireless power transmission devices. The method 400 concludes at block 416 by instructing the one of the plurality of wireless power transmission devices to wirelessly transmit power to one of the set of data collection devices.

In exemplary embodiments, the deployment location of each of the data collection devices is determined based on the data to be collected by the data collection devices and the location of the power generation devices is determined based on the location of the natural power sources. Once the locations of the data collection devices and the power generation devices are determined, multiple wireless power transmission paths from each natural power source to the deployment location of the data collection devices are identified. In exemplary embodiments, an estimated power transmission loss for each of the multiple wireless power transmission paths is calculated and a wireless power transmission path from the multiple wireless power transmission paths based at least in part on the estimated power transmission loss is selected. The locations of the wireless transmission devices are then determined based on the selected wireless power transmission path. In exemplary embodiments, at least one of the multiple wireless power transmission paths includes one of the plurality of wireless power transmission devices.

In exemplary embodiments, the obtained geographic data regarding the environment in which the data collection devices, the wireless power transmission devices, and the power generation devices will be deployed is analyzed and divided into a grid, e.g., a matrix of cells that each represents a physical portion of the environment. In exemplary embodiments, a power generation grid and an energy loss grid are created and used to determine deployment locations for the data collection devices, the wireless power transmission devices, and the power generation devices. In exemplary embodiments, the power generation grid is created by dividing the environment into fixed size cells and labeling each of the cells with an estimated power generation capacity of the natural power sources located in each cell. In exemplary embodiments, the energy loss grid is created by dividing the environment into fixed size cells and labeling each cell with an estimated power transmission loss associated with wireless power transmission across the cell.

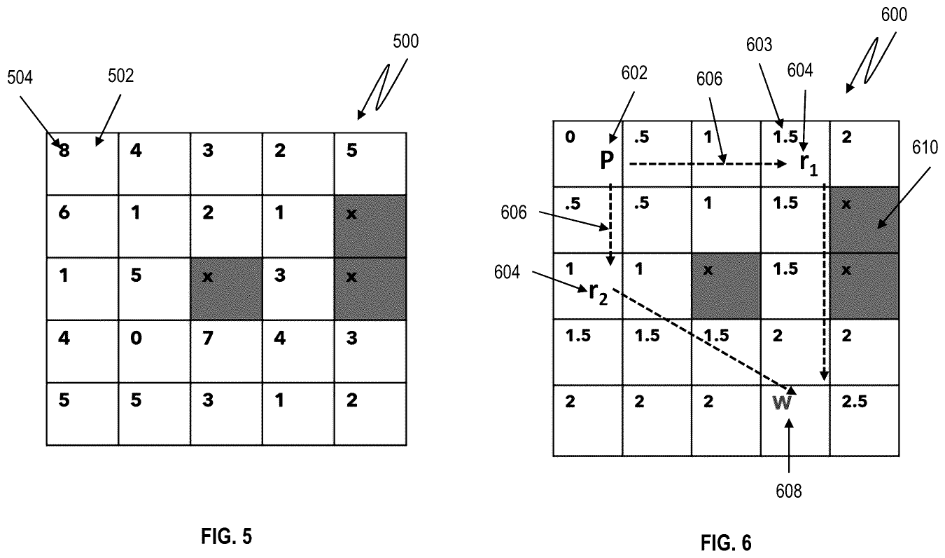

Referring now to FIG. 5, a power generation grid 500 for an environment in accordance with one or more embodiments of the present disclosure is shown. In exemplary embodiments, the power generation grid 500 is created by dividing the environment into fixed size cells and labeling each of the cells with an estimated power generation capacity of the natural power sources located in each cell. The estimated power generation capacity of the natural power sources located in each cell is obtained based on the geographic data obtained for the environment. In one embodiment, the power generation grid 500 is created by, and stored on, a computing environment 100, such as the one shown in FIG. 1. As illustrated, the power generation grid 500 includes a plurality of cells 502 that are arranged in a matrix. In exemplary embodiments, each cell represents a portion of the environment, for example a cell may represent a one-hundred-square-foot area of the environment. Each cell 502 includes an estimated power generation capacity 504 of a natural power source disposed in the area represented by the cell 502.

In exemplary embodiments, the power generation grid 500 may be periodically, or continuously, updated based on changes in the geographic data for the environment. For example, the estimated power generation capacity of the natural power sources such as solar and wind power can frequently change based on real-time conditions in the environment, such as changes to the cloud density or wind intensity in the different portions of the environment. As a result of the updates to the power generation grid, the deployment location of one or more of the power generation devices, the wireless power transmission devices, and the data collection devices may be updated.

Referring now to FIG. 6, an energy loss grid 600 for an environment in accordance with one or more embodiments of the present disclosure is shown. In exemplary embodiments, the energy loss grid 600 is created by dividing the environment into fixed size cells and labeling each cell with an estimated power transmission loss associated with wireless power transmission across the cell. In one embodiment, the energy loss grid 600 is created by, and stored on, a computing environment 100, such as the one shown in FIG. 1. In exemplary embodiments, the energy loss grid 600 may be periodically, or continuously, updated based on changes in the geographic data for the environment. For example, the estimated power transmission loss can change based on real-time conditions in the environment, such as changes to the cloud density or rain in portions of the environment. As a result of the updates to the energy loss grid, the deployment location of one or more of the power generation devices, the wireless power transmission devices, and the data collection devices may be updated.

In exemplary embodiments, the energy loss grid 600 includes the same arrangement of cells as the power generation grid 500. In one embodiment, a data collection device 608 is deployed to a fixed location to collect data at that location. The location of a data collection device 608 is determined based on the data that is being collected. For example, the data collection device 608 can include a Geiger counter that is used to periodically measure radiation levels at a location for a specified duration.

Next, based on the power needs of the data collection device 608, deployment locations for the wireless power transmission devices and the power generation devices are determined using the energy loss grid 600. In exemplary embodiments, the energy loss grid 600 includes cells 610 that include obstructions that prevent wireless power transmission across the area represented by the cells 610. In exemplary embodiments, a location for a power generation device 602 is evaluated based on the estimated power generation capacity of a location and the estimated power transmission loss between the location and the data collection device 608. The energy loss grid 600 includes a cumulative estimated power transmission loss 603 for a transmission path 606. For example, the power transmission loss from the power generation device 602 to the wireless power transmission device (r1) 604 is 1.5. The cumulative estimated power transmission loss 603 is obtained by adding the estimated power transmission loss between adjacent cells.

In exemplary embodiments, the deployment locations of each of the one or more power generation devices and the wireless power transmission devices are determined based at least in part on the power generation grid and the energy loss grid. In one embodiment, the optimal position of the power generation devices (P) 602 and the wireless transmission devices (r) 604 are determined using the following equation:

$$max . {\sum }_{i}^{m} {\sum }_{j}^{n} [ {P}_{ij} {X}_{ij} - min . {\sum }_{k}^{m} {\sum }_{l}^{n} {Y}_{kl} \cdot {R}_{kl} ]$$

where Pᵢⱼ is the power generation capacity of cell i,j; Xᵢⱼ=0 if an obstacle is present in cell i,j and is 1 otherwise, Yₖₗ=∞ if an obstacle is present in cell k,l and is 1 otherwise; and Rₖₗ is the power transmission loss across cell k,l.

Various embodiments are described herein with reference to the related drawings. Alternative embodiments can be devised without departing from the scope of the present disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of #8% or 5%, or 2% of a given value.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method for forming a wireless power grid in an environment, the method comprising:
determining an activity to be performed by a set of data collection devices in the environment;
obtaining geographic data regarding the environment;
identifying natural power sources in the environment based on the geographic data;
deploying one or more power generation devices to one or more of the natural power sources in the environment;
deploying the set of data collection devices in the environment to perform the activity;
deploying a plurality of wireless power transmission devices to the environment;
instructing the one or more power generation devices to collect power from the natural power sources and to wirelessly transmit power to one of the plurality of wireless power transmission devices; and
instructing the one of the plurality of wireless power transmission devices to wirelessly transmit power to one of the set of data collection devices.

2. The method of claim 1, further comprising calculating a total power required by the set of data collection devices to complete the activity, wherein a number of the one or more power generation devices is determined based at least in part on the total power required.

3. The method of claim 1, wherein the one or more power generation devices include one or more of a hydroelectric power generation device, a solar power generation device, and a wind power generation device.

4. The method of claim 1, further comprising:
identifying a deployment location of a first data collection device of the set of data collection devices in the environment;
identifying multiple wireless power transmission paths from each natural power source to the deployment location;
calculating an estimated power transmission loss for each of the multiple wireless power transmission paths; and
selecting a wireless power transmission path from the multiple wireless power transmission paths based at least in part on the estimated power transmission loss.

5. The method of claim 4, wherein at least one of the multiple wireless power transmission paths include one of the plurality of wireless power transmission devices.

6. The method of claim 1, further comprising creating a power generation grid for the environment based on the obtained geographic data, wherein the power generation grid based includes a location of each of the natural power sources and an estimated power generation capacity of the natural power sources.

7. The method of claim 6, further comprising creating an energy loss grid for the environment based on the obtained geographic data, wherein the energy loss grid includes a matrix of cells that represent portions of the environment and wherein the energy loss grid includes an estimated power transmission loss between cells.

8. The method of claim 7, wherein deployment locations of each of the one or more power generation devices and the wireless power transmission devices are determined based at least in part on the power generation grid and the energy loss grid.

9. A computing system having a memory having computer readable instructions and one or more processors for executing the computer readable instructions, the computer readable instructions controlling the one or more processors to perform operations comprising:
determining an activity to be performed by a set of data collection devices in an;
obtaining geographic data regarding the environment;
identifying natural power sources in the environment based on the geographic data;
deploying one or more power generation devices to one or more of the natural power sources in the environment;
deploying the set of data collection devices in the environment to perform the activity;
deploying a plurality of wireless power transmission devices to the environment;
instructing the one or more power generation devices to collect power from the natural power sources and to wirelessly transmit power to one of the plurality of wireless power transmission devices; and
instructing the one of the plurality of wireless power transmission devices to wirelessly transmit power to one of the set of data collection devices.

10. The computing system of claim 9, wherein the operations further comprise calculating a total power required by the set of data collection devices to complete the activity, wherein a number of the one or more power generation devices is determined based at least in part on the total power required.

11. The computing system of claim 9, wherein the one or more power generation devices include one or more of a hydroelectric power generation device, a solar power generation device, and a wind power generation device.

12. The computing system of claim 9, wherein the operations further comprise:
identifying a deployment location of a first data collection device of the set of data collection devices in the environment;
identifying multiple wireless power transmission paths from each natural power source to the deployment location;
calculating an estimated power transmission loss for each of the multiple wireless power transmission paths; and
selecting a wireless power transmission path from the multiple wireless power transmission paths based at least in part on the estimated power transmission loss.

13. The computing system of claim 12, wherein at least one of the multiple wireless power transmission paths include one of the plurality of wireless power transmission devices.

14. The computing system of claim 9, wherein the operations further comprise creating a power generation grid for the environment based on the obtained geographic data, wherein the power generation grid based includes a location of each of the natural power sources and an estimated power generation capacity of the natural power sources.

15. The computing system of claim 14, wherein the operations further comprise creating an energy loss grid for the environment based on the obtained geographic data, wherein the energy loss grid includes a matrix of cells that represent portions of the environment and wherein the energy loss grid includes an estimated power transmission loss between cells.

16. The computing system of claim 15, wherein deployment locations of each of the one or more power generation devices and the wireless power transmission devices are determined based at least in part on the power generation grid and the energy loss grid.

17. A computer program product comprising a computer readable storage medium having program instructions embodied therewith, the program instructions executable by a processor to cause the processor to perform operations comprising:
determining an activity to be performed by a set of data collection devices in an environment;
obtaining geographic data regarding the environment;
identifying natural power sources in the environment based on the geographic data;
deploying one or more power generation devices to one or more of the natural power sources in the environment;
deploying the set of data collection devices in the environment to perform the activity;
deploying a plurality of wireless power transmission devices to the environment;
instructing the one or more power generation devices to collect power from the natural power sources and to wirelessly transmit power to one of the plurality of wireless power transmission devices; and
instructing the one of the plurality of wireless power transmission devices to wirelessly transmit power to one of the set of data collection devices.

18. The computer program product of claim 17, wherein the operations further comprise calculating a total power required by the set of data collection devices to complete the activity, wherein a number of the one or more power generation devices is determined based at least in part on the total power required.

19. The computer program product of claim 17, wherein the one or more power generation devices include one or more of a hydroelectric power generation device, a solar power generation device, and a wind power generation device.

20. The computer program product of claim 17, wherein the operations further comprise:
identifying a deployment location of a first data collection device of the set of data collection devices in the environment;
identifying multiple wireless power transmission paths from each natural power source to the deployment location;
calculating an estimated power transmission loss for each of the multiple wireless power transmission paths; and
selecting a wireless power transmission path from the multiple wireless power transmission paths based at least in part on the estimated power transmission loss.
